(19) United States
(12) Patent Application Publication
(10) Pub. No.: US 2006/0179985 A1
(43) Pub. Date: Aug. 17, 2006

(54) Electric hand power tool

(76) Inventors: Ulrich Bohne, Kohlberg (DE); Eugen Hild, Aichtal (DE); Heiko Roehm, Stuttgart (DE)

Correspondence Address: STRIKER, STRIKER & STENBY, 103 East Neck Road, Huntington, NY, 11743, US

(21) Appl. No.: 11/403,651

(22) Filed: Apr. 13, 2006

Related U.S. Application Data
(63) Continuation-in-part of application No. 10/719,752, filed on Nov. 21, 2003.

(30) Foreign Application Priority Data
Nov. 22, 2002 (DE) 10254577.4
Feb. 7, 2003 (DE) 10305033.7

(51) Int. Cl. B26D 7/06

(52) U.S. Cl. 83/78; 83/100

(57) ABSTRACT

An electric hand power tool has a housing, a rotatably driven tool, a protective hood which at least partially covers the tool, a handle and an auxiliary handle for a two-hand guidance of the power tool, the auxiliary handle being hollow and formed as a withdrawal passage for a removed material thrown from the rotatably driven tool, the auxiliary handle having an inlet which is formed so that a radiating direction of the removed material from the rotatably driven tool is substantially tangential to a workpiece periphery in an inlet of the auxiliary handle, the inlet of the auxiliary handle being formed so that an inflow direction of the motor spent air coincides with the radiating direction of the removed material from the tool, and an air-cooled electric motor which drives the tool and is accommodated in the housing, the housing having an air passage provided with an air inlet opening for a motor spent air, the air passage being screw-shaped in direction of the motor spent air, which is directed in an opposite direction of the rotatably driven tool.

### CROSS-REFERENCE TO A RELATED APPLICATION

This application is a continuation-in-part of patent application Ser. No. 10/719,752, filed on Nov. 21, 2003.

Patent application Ser. Nos. 10/719,753 and 11/318,968 contain a subject matter which is similar to a subject matter of the present invention.

### BACKGROUND OF THE INVENTION

The present invention relates to an electric hand power tool.

In electric hand power tools with rotatable tools, such as a hand circular saw, wall chase cutter, stone saw, angle grinder, concrete grinder, plane, and the like, the material which is removed by the rotatable tool from the workpiece, for example chips or dust, is discharged from the protective hood directly into environment. Thereby the material removed for example during longitudinal cutting covers the cutting line and/or directly hits the operator, that significantly negatively affect the work with the machine.

### SUMMARY OF THE INVENTION

Accordingly, it is an object of the present invention to provide an electric hand power tool which avoids the disadvantages of the prior art.

In keeping with these objects and with others which will become apparent hereinafter, one feature of the present invention resides, briefly stated, in an electric hand power tool, comprising a housing, a rotatably driven tool, a protective hood which at least partially covers the tool, a handle and an auxiliary handle for a two-hand guidance of the power tool, the auxiliary handle being hollow and formed as a withdrawal passage for a removed material thrown from the rotatably driven tool, the auxiliary handle having an inlet which is formed so that a radiating direction of the removed material from the rotatably driven tool is substantially tangential to a workpiece periphery in an inlet of the auxiliary handle, the inlet of the auxiliary handle being formed so that an inflow direction of the motor spent air coincides with the radiating direction of the removed material from the tool, and an air-cooled electric motor which drives the tool and is accommodated in the housing, the housing having an air passage provided with an air inlet opening for a motor spent air, the air passage being screw-shaped in direction of the motor spent air, which is directed in an opposite direction of the rotatably driven tool.

When the electric hand power tool is designed in accordance with the present invention, it has the advantage that the removed material composed of chips or dust is thrown directly from the rotatable tool into the hollow auxiliary handle, and by the kinetic energy of the rotation has a relatively high entry speed. The removed material is picked up directly at the location of its generation, or in other words at the tool outlet and thrown far from the operating zone. When at the end of the hollow auxiliary handle a suction device is connected, the transportation of the removed material through the auxiliary handle is thereby enhanced and the removed material is collected at another location.

In accordance with a preferable embodiment of the invention, in the machine housing an air-cooled electric motor is provided for driving the tool, and the machine housing is formed so that the motor spent air flows into the auxiliary handle. The motor spent air is supplied in the same direction into the inlet of the auxiliary handle, in which the removed material leaves the rotatable tool and enters the inlet. The flowing-in motor spent air supports the conveyance of the removed material toward the outlet in the auxiliary handle, so that a clogging of the auxiliary handle by the removed material is reliably prevented.

In cases in which the rotary directions of the electric motor and the tool are inverted because of a transmission arranged between the electric motor and the rotatable tool, a closed air passage for guiding the motor spent air is provided for producing the same blowing-in direction of the motor spent air and removed material in accordance with an advantageous embodiment of the invention. The air passage is screw-shaped and expands to the inlet of the bracket handle.

In accordance with a preferable embodiment of the present invention, the hollow auxiliary handle is formed as a bracket handle which is set with its one handle end on the protective hood and is fixed on or near its other handle end, which is opposite to the protective hood, on a housing part of the machine housing which receives the electric motor. Thereby a solid mechanical connection of the auxiliary handle with the machine housing is provided, and a reliable handling of the machine both for left- and right-handed users is possible, that allows a flexible handle position in different working applications.

In accordance with a preferable embodiment of the present invention, the auxiliary handle or an outlet pipe which surrounds an outlet of the auxiliary handle is formed turnable. Thereby the throwing direction of the removed material can be adjusted so that it does not hinder the operator in any work application. The turnable auxiliary handle which is arrestable in the adjusted turning position, additionally provides an individual optimization of the ergonomics of the machine by adaptation to individual gripping habits of the operator.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view of an electric hand circular power saw in accordance with the present invention;

FIGS. 2a and 2b show a plan view of the electric hand circular power saw of FIG. 1 without a supporting plate and with a handle in two different positions;

FIG. 2c is a view showing a cross section of FIG. 2b;

FIG. 3 is a side view of the electric hand circular power saw of FIG. 2, after removal of a protective hood and a circular saw blade;

FIG. 4 is a side view of the electric hand circular power saw of FIG. 1, with a removed protective hood for the circular saw blade.

### DESCRIPTION OF THE PREFERRED EMBODIMENTS

An electric hand circular power saw is shown in the drawings as an example for an electric hand power tool for chip-removing or grinding treatment of workpieces. It has a two-shell housing 10 with a handle 11 formed on it for guiding and handling of the power tool and with a motor housing 12 placed on it and accommodating an air-cool electric motor.

The electric motor drives a drive shaft 13 through a not shown one-stage transmission, and a saw blade 14 is mounted on the drive shaft. The circular saw blade 14 is covered in an upper region by a protective hood 15 which is screwed to the housing 10. The protective hood 15 extends to a support plate 16 which is connected with the machine housing 10. The support plate 16 is used for placing the power tool on the workpiece during a sawing process. The circular saw blade 14 extends through the support plate 16 and projects beyond it, downwardly more or less depending on a desired cutting depth.

For adjustment of the cutting depth to the machine, the support plate 16 is turnable about a turning axle which is fixed on the machine housing 10 forwardly on the circular saw blade 14 as seen in a working direction. The selected turning position is fixed by an adjusting device 17.

For providing a two-hand guidance of the power tool for sawing, the power tool has an auxiliary handle 21. It is formed as a bracket handle and arranged forwardly of the drive shaft 13 of the circular saw blade 14 as considered in the working direction of the power tool, near its front region on the machine housing 10. The auxiliary handle which is identified herein below as the bracket handle 21 extends in a plane which is transverse to a plane of the handle 11. Its one handle end is placed on the protective hood 15. Its gripping region 211 which is substantially parallel to the rotary axis of the circular saw blade 14, extends above the support plate 16 at a distance from it. Its other gripping end is fixed on the motor housing 12. Thereby a very solid mechanical connection of the bracket handle 21 on the machine housing 10 is guaranteed.

By means of the auxiliary handle 21, the power tool can be placed very accurately planely on the workpiece, and during sawing can be held and guided very well with two hands. The great gripping region of the bracket handle 21 provides an ergonomic and reliable handling of the power tool in all work applications, both for a right-handed and a left-handed person. Moreover, it is possible to support the power tool with the bracket handle 21 in its center of gravity.

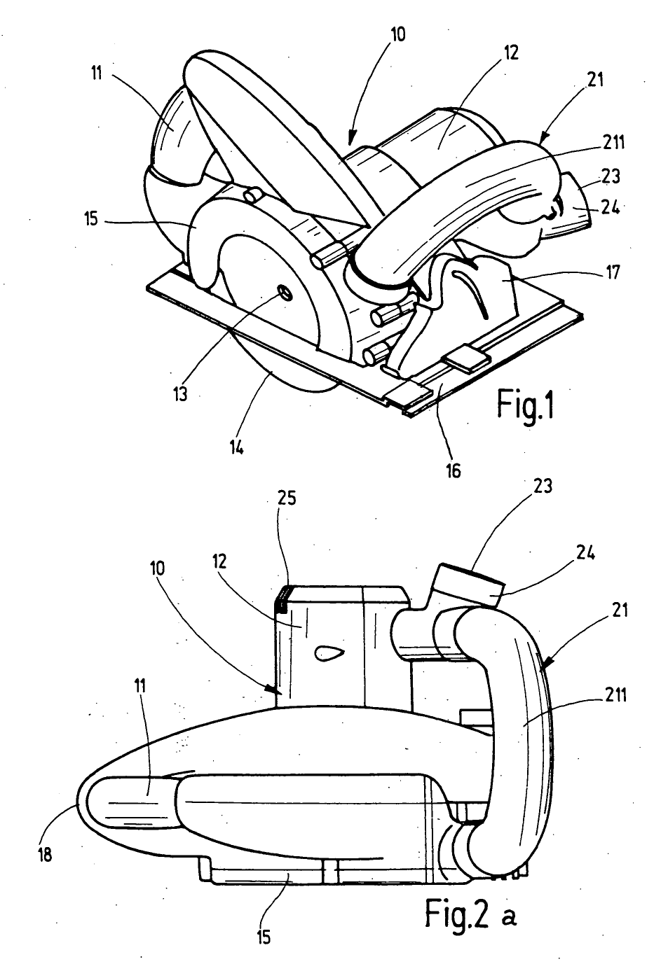

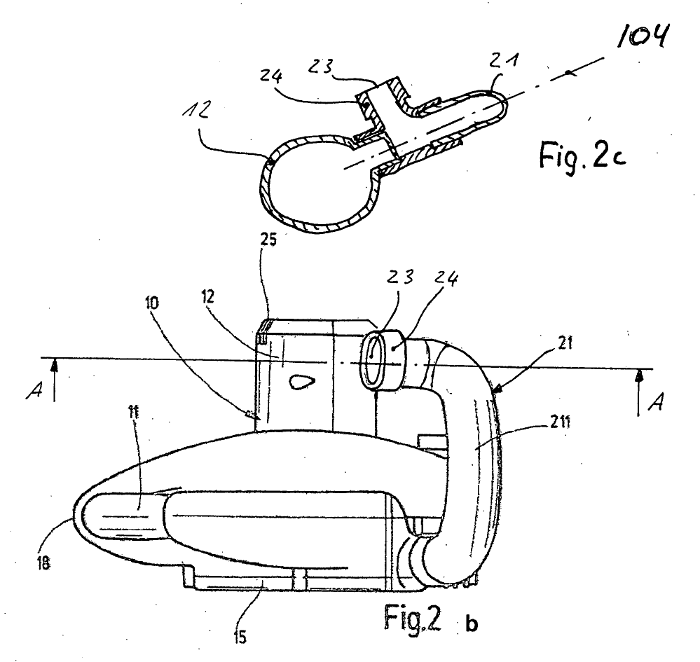

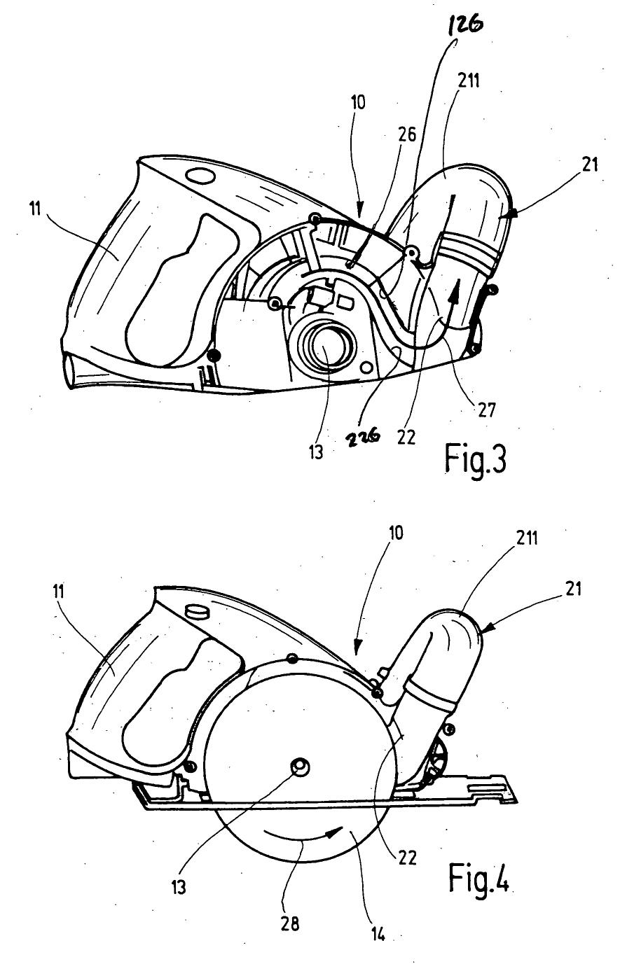

The bracket handle 21 is hollow and has an inlet 22 which is open to the interior of the protective hood 15 as shown in FIGS. 3 and 4. It also has an outlet 23 arranged behind the handle region 211 as shown in FIGS. 1 and 2. Preferably the outlet 23 is located at or near the end of the bracket handle 21 which faces away from the inlet 22. The outlet 23 is enclosed by an outlet pipe 24 which can be formed preferably turnable. For the air cooling of the electric motor, the motor housing 12 has air inlet slots 25 shown in FIG. 25. Air which is aspirated by a not shown air impeller connected for rotation with the driven shaft of the electric motor is aspirated through the air inlet slots. The air which is aspirated by the air impeller passes through the electric motor and is blown out as a heat-withdrawing motor spent air, and it is guided so that it flows into the inlet 22 of the hollow bracket handle 21. For this purpose an air passage 26 is formed in the housing 10 and defined by two bow-like side walls 126, 226 which keep the motor spent air away from interfering with the saw blade 14 and lead the air undisturbed into the inlet 22 of the bracket handle 21. It expands toward the inlet 22 of the bracket handle 21 and opens into the inlet 22 as shown in FIG. 3.

The air is blown by the air impeller from the interior of the electric motor into an air inlet opening of the air passage 26 which is covered in FIG. 3. The motor spent air flows from the motor housing then enters the protective hood, and next enters the inlet 22 of the bracket handle 21 carrying the debris so as to take away all removed material, as shown by the arrow 27 in FIG. 3, flows through the air passage 26 of the hollow bracket handle 21, and is discharged through the outlet 23 which is formed in the bracket handle 21 and surrounded by the outlet pipe 24. The outlet pipe 24 forms an extra mouthpiece as a cover for the outlet pipe 23 so that the pipe 24 together with the pipe 23 are swivelable around an axis 104, and therefore the outlet direction can be adjusted. The outlet pipe 24 is oriented so that the flow direction of the motor spent air flowing out here is oriented away from the operator of the power tool. When the outlet pipe 24 is turnably movable, the operator can individually adjust the air discharge device as convenient to him or as necessary for the work applications.

When the electric hand power tool is designed in this way with the special above-described path of air, noises of three sources are diminished, namely the noise of the electric motor, the noise of the motor-cooling fan, and the noise of the saw blade, which are dampened and diminished with the bracket handle 21. Air has time to expand, to relax, and this way to diminish the noises.

Since as mentioned herein above, a one-stage transmission is arranged between the electric motor and the drive shaft 13 of the circular saw blade 14, the rotary directions of the rotor of the electric motor and the circular saw blade 14 are inverted. The rotary direction of the circular saw blade 14 is identified in FIG. 4 by the arrow 28. For supplying the motor spent air which leaves the electric motor to enhance the flow through the air passage 26 into the bracket handle 21, the air passage 26 is closed and formed screw-shaped, as can be seen partially in FIG. 3. It extends from its air inlet opening to the inlet 22 of the bracket handle 21 as an axially expanding spiral, wherein the throughgoing diameter of the air passage 26 is preferably continuously increased.

The hollow bracket handle 21 is used for taking the saw dust which is produced with the circular saw blade 14 and throwing it from the workpiece and from the operator in an opposite direction. For this purpose the inlet 22 of the bracket handle 21 is designed so that the radiating direction of the saw dust or the saw chips identified by arrow 29 in FIG. 4 is fixed so that the saw dust gets into the inlet 22 of the bracket handle 21 directly after it leaves the saw blade cutting edges. Preferably for this purpose the inlet 22 is placed so that the normal to the inlet opening coincides with the tangential radiating or throwing direction 29 of the saw dust. The saw dust has a relatively great inlet speed in the bracket handle 21 due to the kinetic energy of the rotary movement. The spent air of the electric motor which additionally is blown in the same direction as identified with arrow 27 in FIG. 3, supports the dust or chip conveyance and reliably prevents clogging of the bracket handle 21.

By turning of the outlet pipe 24 on the handle bracket 21, the saw dust blown from the outlet 23 of the handle bracket 21 can be deviated in the direction, in which it burdens the operator the least. In addition, a collecting container or a suction hose for a saw dust aspiration can be connected to the outlet pipe 24.

The two-shell housing 10 is produced by injection molding of synthetic plastic material. The handle 11 and the air passage 26 can be made the same way. The bracket handle 21 is formed as an insert; however, it can be also molded with it. The screw-shaped air passage 26 which expands toward the inlet 22 from the bracket handle 21 is formed in parts on both shells, to complete the air passage 26 by assembly of the shells.

In a modification of the above mentioned electric hand circular power saw, the bracket handle 21 is turnable about the inlet 22 which opens to the protective hood 15 and is arrestable in arbitrary or predetermined turning positions. Thereby in addition to the possibility for adjustment of the dust throwing direction, also an ergonomic effect can be produced.

The present invention is not limited to the above described electric hand circular power saw. It also can be used for all hand-guided electric power tool with the rotatable tools, such as, for example, masonry mills, rock saws, and angle grinders, concrete grinders, eccentric grinders, etc.

It will be understood that each of the elements described above, or two or more together, may also find a useful application in other types of constructions differing from the types described above.

While the invention has been illustrated and described as embodied in electric hand power tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An electric hand power tool, comprising a housing; a rotatably driven tool; a protective hood which at least partially covers said tool; a handle and an auxiliary handle for a two-hand guidance of the power tool, said auxiliary handle being hollow and formed as a withdrawal passage for a removed material thrown from the rotatably driven tool, said auxiliary handle having an inlet which is formed so that a radiating direction of the removed material from said rotatably driven tool is substantially tangential to a workpiece periphery in an inlet of said auxiliary handle, said inlet of said auxiliary handle being formed so that an inflow direction of the motor spent air coincides with the radiating direction of the removed material from said tool; and an air-cooled electric motor which drives said tool and is accommodated in said housing, said housing having an air passage provided with an air inlet opening for a motor spent air, said air passage extending as a spiral and being screw-shaped in direction of the motor spent air, which is directed in an opposite direction of said rotatably driven tool.

2. An electric hand power tool as defined in claim 1, wherein said auxiliary handle has an inlet which is open to an interior of said protective hood and an outlet arranged at or near a handle end facing away from said inlet.

3. An electric hand power tool as defined in claim 2; and further comprising an outlet pipe which encloses said outlet.

4. An electric hand power tool as defined in claim 4, wherein said outlet pipe is configured as turnable pipe.

5. An electric hand power tool as defined in claim 1; and further comprising an air-cooled electric motor which drives said tool and is arranged in said housing, said housing being formed so that a motor spent air which leaves said air-cooled electric motor flows into said auxiliary handle.

6. An electric hand power tool as defined in claim 1, wherein said housing has an air passage provided with an air inlet opening for a motor spent air, said air passage expanding toward an inlet of said auxiliary handle and opening into said inlet of said auxiliary handle.

7. An electric hand power tool as defined in claim 1, wherein said auxiliary handle is formed as a bracket handle and has one handle end which is placed on said protective hood and another handle end with which said bracket handle is fixed at or near a housing part of said housing which accommodates an electric motor.
